(19) United States
(12) Patent Application Publication
(10) Pub. No.: US 2025/0072317 A1
(43) Pub. Date: Mar. 6, 2025

(54) MOWER OBSTACLE AVOIDANCE SYSTEM

(71) Applicant: DEERE & COMPANY, MOLINE, IL (US)

(72) Inventors: Robert D. Haun, FUQUAY VARINA, NC (US); JEFFREY S. THOMPSON, Dundee, FL (US); Stefan Plonka, SAARBRÜCKEN (DE)

(21) Appl. No.: 18/456,827

(22) Filed: Aug. 28, 2023

(51) Int. Cl. A01D 34/00; G05D 1/02

(52) U.S. Cl. CPC A01D 34/008; A01D 2101/00

(57) ABSTRACT

A mower obstacle avoidance system includes a pair of sensors mounted on a robotic mower, each sensor emitting ultrasonic signals in a trajectory in front of the robotic mower, and receiving reflected signals from the other sensor. A controller commands a traction drive system to stop and turn the mower if either of the pair of sensors receives a reflected ultrasonic signal from an object at a stop distance in front of the robotic mower, if the object also is within a window of passage based on a height of cut, a width and a height of the robotic mower.

### FIELD OF THE INVENTION

This invention relates to obstacle avoidance systems for grass mowing machines such as robotic mowers and other mowers having guidance systems.

### BACKGROUND OF THE INVENTION

Mower obstacle avoidance systems may include torque sensing, accelerometers, bump detection, or ultrasonic sensors. Ultrasonic sensors may detect obstacles without coming into contact with an object or obstacle, by transmitting energy in the form of ultrasonic sound waves and then receiving waves that reflect from the object or obstacle back to the sensor.

However, ultrasonic sensors may not detect some objects or obstacles such as walls or posts that are positioned at an angle relative to the mower, because the sound energy may be deflected off the angled object in other directions, not back to the ultrasonic sensor on the mower. Ultrasonic sensors also may receive signals reflected from objects or obstacles that do not block the mower.

A mower obstacle avoidance system is needed with improved detection for objects or obstacles that the mower is approaching at an angle. A mower obstacle avoidance system is needed that can determine if an object or obstacle is in the path of a mower.

### SUMMARY OF THE INVENTION

A mower obstacle avoidance system includes a left ultrasonic sensor and a right ultrasonic sensor mounted on a mower. The left ultrasonic sensor sends ultrasonic signals at a first frequency and the right ultrasonic sensor sends ultrasonic signals at a second frequency. Each ultrasonic sensor receives ultrasonic signals reflected back at both the first frequency and the second frequency. If an object is detected, a vehicle controller commands the mower's traction drive system to slow down the mower and, if the object is within the mower's zone of passage, stop and turn based on a comparison of reflected ultrasonic signals received by the first and second ultrasonic sensors. The system detects objects or obstacles positioned at angles relative to the mower, and determines if they are in the path of the mower.

### BRIEF DESCRIPTION OF THE DRAWINGS

FIG. 1 is a top view of a mower obstacle avoidance system according to a first embodiment of the invention.

FIG. 2 is a side view of a mower obstacle avoidance system according to a first embodiment of the invention.

FIG. 3 is a logic diagram of a mower obstacle avoidance system according to a first embodiment of the invention.

FIG. 4 is a schematic diagram of a mower obstacle avoidance system wherein ultrasonic signals are deflected by object O1 at a first approach angle according to a first embodiment of the invention.

FIG. 5 is a schematic diagram of a mower obstacle avoidance system wherein ultrasonic signals are deflected by object O1 at a second approach angle according to a first embodiment of the invention.

FIG. 6 is a schematic diagram of a mower obstacle avoidance system wherein ultrasonic signals are deflected by object O2 at a first approach angle to according to a first embodiment of the invention.

FIG. 7 is a schematic diagram of a mower obstacle avoidance system wherein ultrasonic signals are deflected by object O2 at a second approach angle according to a first embodiment of the invention.

FIG. 8 is a schematic diagram of a mower obstacle avoidance system wherein ultrasonic signals are deflected by object O2 at a third approach angle according to a first embodiment of the invention.

FIG. 9 is a schematic diagram of a mower obstacle avoidance system wherein ultrasonic signals are deflected by object O2 at a fourth approach angle according to a first embodiment of the invention.

### DESCRIPTION OF THE PREFERRED EMBODIMENT

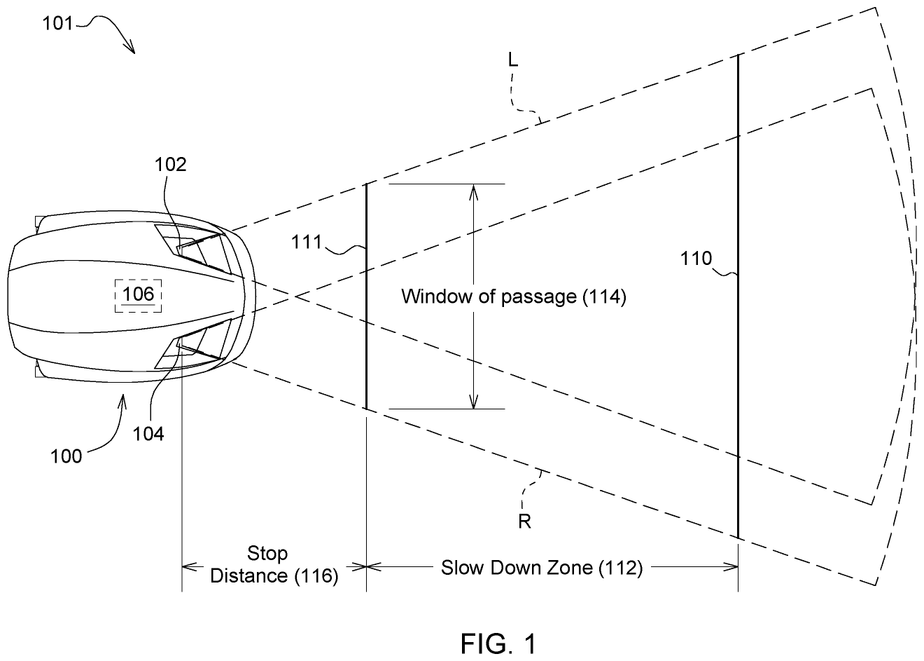

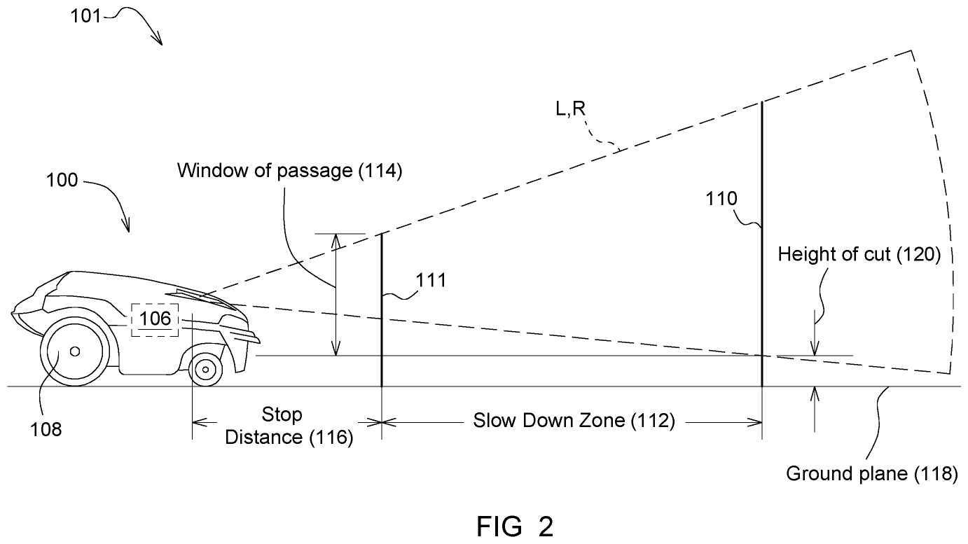

As shown in FIGS. 1 and 2, mower obstacle avoidance system 101 may include a pair of ultrasonic sensors: left ultrasonic sensor 102 and right ultrasonic sensor 104. The left ultrasonic sensor may be mounted near the left front corner, and the right sensor near the right front corner, of a grass mowing machine such as robotic mower 100. Each ultrasonic sensor may transmit energy in the form of ultrasonic sound waves and may receive any of the waves that are reflected back from an object or obstacle to the sensor. Alternatively, the mower obstacle avoidance system my include three or more ultrasonic sensors. The obstacle avoidance system may be mounted on robotic mowers or other grass mowing machines having guidance systems such as fairway mowers, lawn tractors or zero turn mowers.

In one embodiment, mower obstacle avoidance system 101 may include two or more ultrasonic sensors, with at least two of the sensors emitting signals at different frequencies. For example, left ultrasonic sensor 102 may emit ultrasonic signal L having a first frequency and right ultrasonic sensor 104 may emit ultrasonic signal R having a second frequency. Ultrasonic signals L and R may be reflected by an object or obstacle back to the same sensor. For example, an obstacle or object may reflect signal L back to the left sensor, and signal R back to the right sensor. The reflected signals may indicate the proximity of the obstacle or object relative to the mower.

In one embodiment, mower obstacle avoidance system 101 may include a two or more sensors that send ultrasonic signals which may be reflected to other sensors. Thus, each sensor may detect ultrasonic signals of two or more frequencies. For example, signal R from right sensor 104 may be reflected as signal [symbol] to the left sensor, and signal L from left sensor 102 may be reflected as signal [symbol] to the right sensor. Each reflected signal may have a deflection angle. The deflection angle may depend on the approach angle of the mower to the obstacle, the orientation of the obstacle relative to the mower, and the shape of the obstacle. Reflected signal [symbol] may have deflection angle a, and reflected signal [symbol] may have deflection angle b. The reflected signals also may have a dispersion angle dependent on the surface roughness of the obstacle.

In one embodiment, mower obstacle avoidance system 101 may include controller 106 that commands a traction drive system to reduce the mower speed below a normal speed if one or both sensors 102, 104 receive ultrasonic signals reflected from an object or obstacle within a maximum distance 110 and minimum distance 111 from the sensor. The maximum and minimum distances are shown in FIGS. 1 and 2, and the area between them is shown as slow down zone 112. If one or more ultrasonic signals are reflected back to one or both sensors from an object or obstacle in the slow down zone, controller 106 may command the traction drive system to slow down the mower speed. For example, the controller may command the wheel motors of a mower's differential drive system to reduce the rotational speeds of rear wheels 108.

In one embodiment, mower obstacle avoidance system 101 may include controller 106 that may track ultrasonic signals reflected from an object or obstacle back to either sensor 102, 104. The controller may command the traction drive system to reduce the speed of the mower if reflected signals are received by either sensor from an object or obstacle in slow down zone 112. If neither sensor continues to receive signals reflected from an object or obstacle that was detected in the slow down zone, the controller may command the mower to return to the normal speed after the mower passes the object's last detected location. Alternatively, the controller may command the mower to return to the normal speed if neither sensor continues to receive reflected signals at stop distance 116 from the object or obstacle. If either sensor continues to receive reflected signals from the object at stop distance 116, the controller may command the traction drive system to stop the mower and turn to avoid the object or obstacle.

In one embodiment, mower obstacle avoidance system 101 may determine if a detected object or obstacle is in window of passage 114 which would block the path of the mower. The window of passage may depend on the location of sensors 102, 104 on mower 100, and may include a minimum height above a ground plane, a maximum height above the mower, and a mower width. The system may determine if a detected object or obstacle is in the window of passage at minimum distance 110 of slow down zone 112, or when the mower reaches stop distance 116 to the object or obstacle. An object or obstacle is within the window of passage if it reflects ultrasonic signals back to either sensor at the stop distance. An object or obstacle is outside the window of passage if it does not reflect ultrasonic signals back to either sensor at the stop distance.

In one embodiment, mower obstacle avoidance system 101 may include a pair of ultrasonic sensors 102, 104 that only detect objects or obstacles above height of cut 120 above ground plane 118, and do not detect grass or other objects below the height of cut. Ultrasonic sensors 102, 104 may be mounted on mower top surface 126 which may be sloped so that ultrasonic signals L, R have a trajectory that is above height of cut 120 through slow down zone 112. Alternatively, controller 106 may ignore any signals reflected from objects or obstacles below height of cut 120.

In one embodiment, mower obstacle avoidance system 101 may stop and turn the mower for objects or obstacles in the window of passage, and move the mower past objects that are outside the window of passage. Each sensor may emit ultrasonic signals in a trajectory based in part on the mower body surface where the sensor is mounted. For example, the trajectory may be generally cone shaped. Left ultrasonic sensor 102 may be positioned between left and right side surfaces 122, 124 which may define the left and right sides of the trajectory from the sensor, and right ultrasonic sensor 104 may be positioned between left and right side surfaces 128, 130 which define the sides of its trajectory.

In one embodiment, mower obstacle avoidance system 101 may include controller 106 which may slow the traction drive system if ultrasonic signals are reflected back to either sensor in slow down zone 112. When the mower reaches stop distance 116 to an object or obstacle, the controller may command the traction drive system to stop the mower if the object is in the window of passage because it reflects signals back to either sensor. At stop distance 116, the controller may command the traction drive system to continue at the reduced speed if the object is not in the window of passage because it does not reflect signals back to either sensor, until the controller determines it has passed the last detected location of the object or obstacle.

In one embodiment, mower obstacle avoidance system 101 may include a controller 106 that commands the traction drive system to turn the mower clockwise or counter clockwise, after stopping, to avoid an object or obstacle. The controller may determine which direction to turn by comparing the ultrasonic signals reflected to each of the pair of sensors. For example, the controller may compare the magnitude of reflected ultrasonic signals to the left sensor and right sensor, the smallest magnitude being the smallest distance to the object or obstacle. A sensor that does not receive a reflected signal may not be included in the comparison. The controller then may command the mower's traction drive system to turn the mower clockwise or counterclockwise until the object or obstacle is not detected.

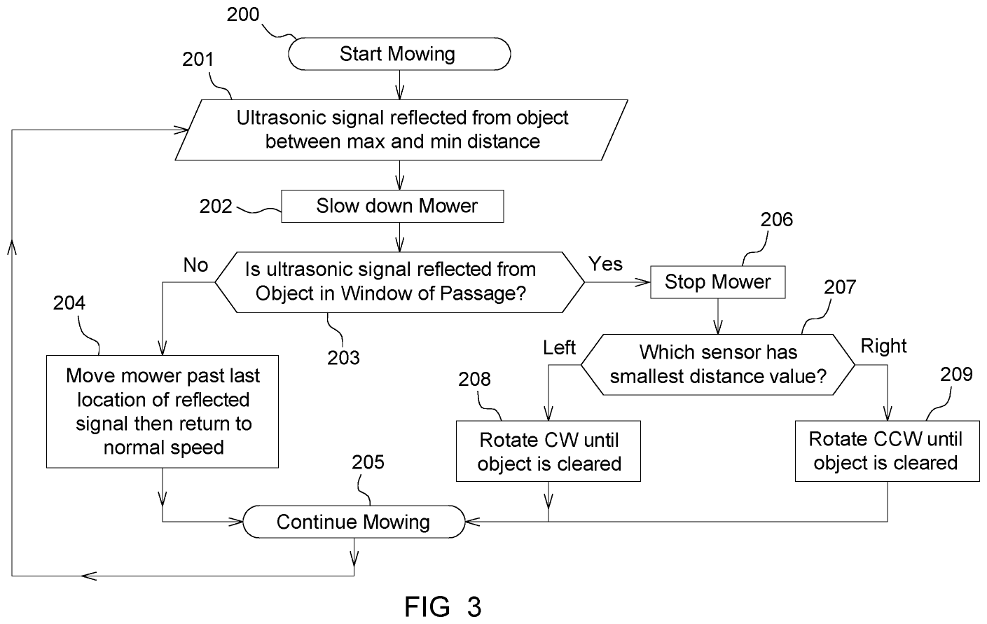

As shown in FIG. 3, the mower obstacle avoidance system may include a controller on a mower such as a robotic mower that may perform logic steps which may be provided in software, The system may be activated when starting mowing in block 200. In block 201, an object is encountered, an ultrasonic signal is reflected to either sensor if the object is between the maximum and minimum distances. In block 202, the controller may command the mower traction drive system to slow down the mower to a reduced speed. In block 203, the mower reaches the stop distance to the object or obstacle and determines if the object is in the window of passage. An object or obstacle is in the window of passage if it is still reflecting an ultrasonic signal to either sensor. If it is in the window of passage, the controller may command the traction drive system to stop the mower in block 206. In block 207 the controller may compare the reflected signals to determine which sensor received a signal with the smallest distance value, or closest proximity to the object or obstacle. If there is no reflected signal, it is not included in the comparison. If the left sensor received a reflected signal with the lowest value, the controller may command the traction drive system to turn the mower clockwise (or to the right) until the object is cleared in block 208. If the right sensor has the lowest value, the controller may command the traction drive system to turn the mower counterclockwise (or to the left) until the object is cleared in block 209. The controller then may command the traction drive system to resume mowing at normal speed in block 205. In block 203, if neither sensor received ultrasonic signals reflected from an object in the window of passage, the controller may move the mower past the last location where an object reflected the signal, and then return the mower to normal speed. Alternatively, the controller may wait to command the traction drive system to speed the mower back up to normal speed until the mower passes the object's location where a sensor last received a reflected signal from it.

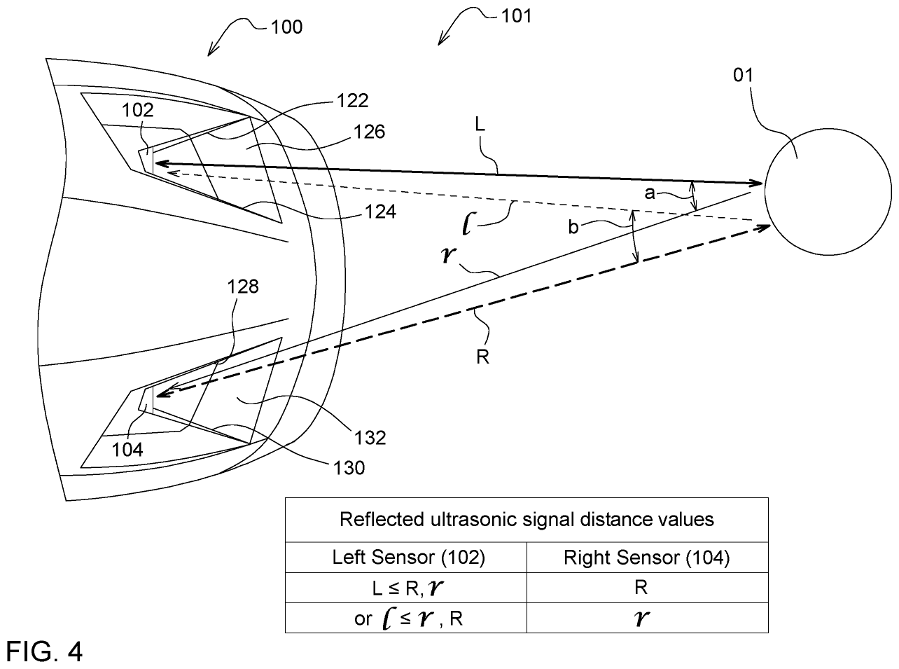

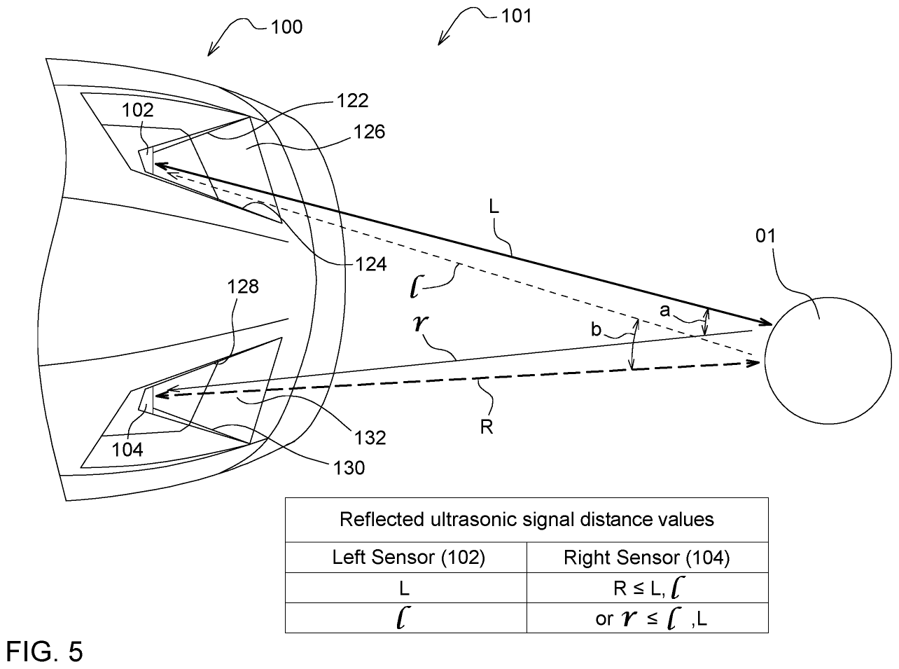

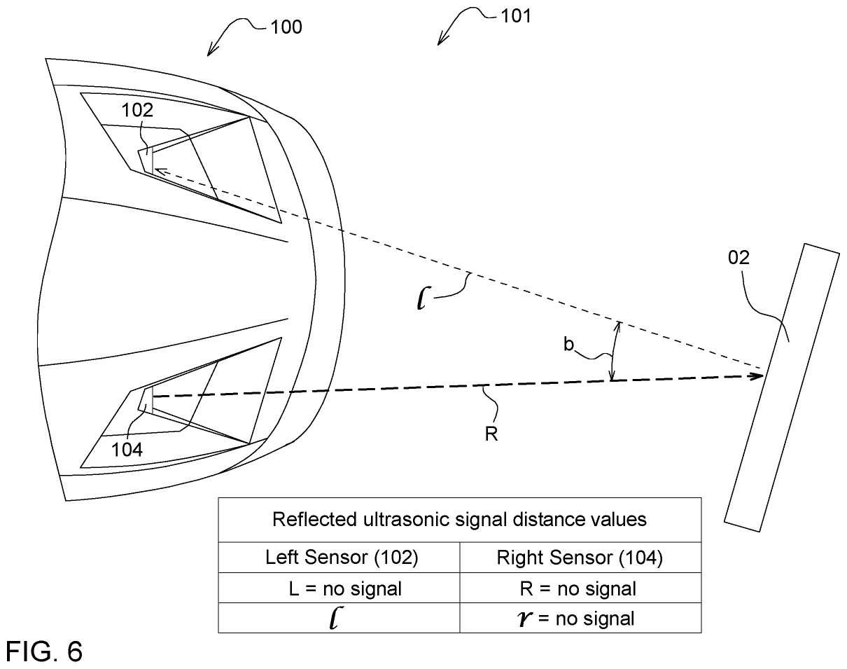

As shown in FIGS. 4 and 5, the mower obstacle avoidance system may be used on a robotic mower approaching object or obstacle O1 having a large dispersion angle such as a generally spherical of cylindrical like object. FIGS. 4 and 5 each show a different approach angle of the mower to the object. Left and right ultrasonic sensors 102, 104 may emit signals L, R toward obstacle O1 which reflects signals back to both sensors. Left sensor 102 may emit signal L to obstacle O1 which reflects signal L back to left sensor 102 and signal [symbol] to right sensor 104 at deflection angle a. Right sensor 104 may emit signal R to obstacle O1 which reflects signal R back to right sensor 104 and signal [symbol] to left sensor 102 at deflection angle b. The controller may compare the reflected ultrasonic signals to determine which sensor received a reflected signal with the lowest value. In FIG. 5, L is less than or equal to R or [symbol] , and [symbol] is less than or equal to [symbol] or R, so the controller may command the traction drive system to turn the mower clockwise (or to the right) to avoid obstacle O1. In FIG. 6, R is less than or equal to L or [symbol] , and/or [symbol] is less than or equal to [symbol] or L, so the controller may command the traction drive system to turn the mower counter clockwise (or to the left) to avoid obstacle O1.

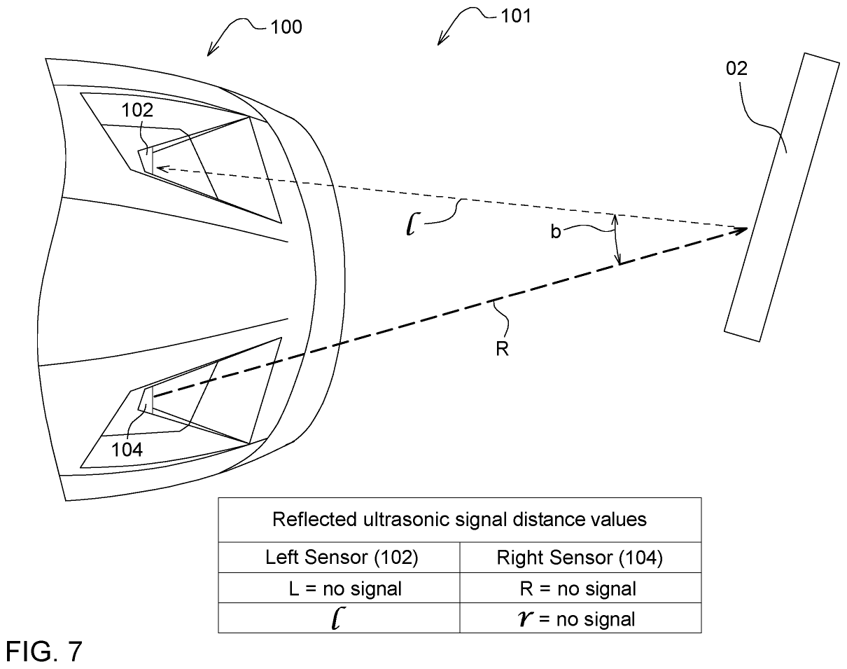

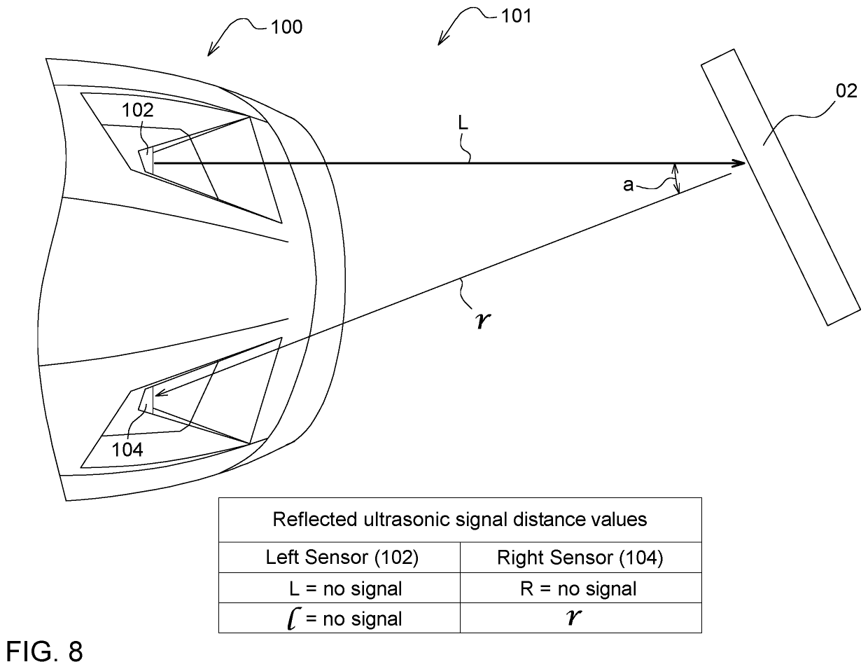

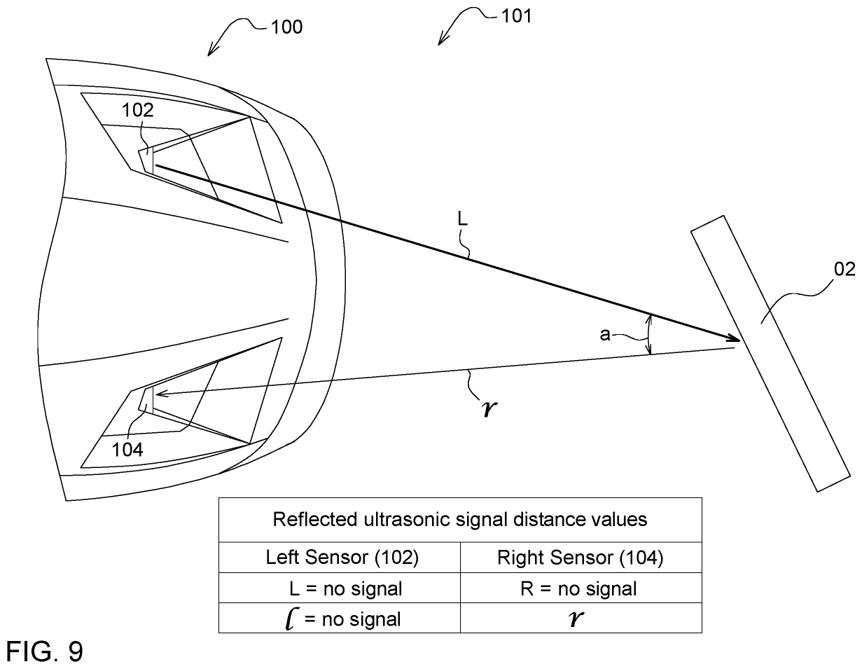

As shown in FIGS. 6-9, the mower obstacle avoidance system may be used on a robotic mower approaching obstacle O2 which may be a flat obstacle such as a wall. The mower approach angle and obstacle position are different in each of FIGS. 6-9. Left and right ultrasonic sensors 102, 104 may emit signals L, R which O2 reflects back to one of the sensors at deflection angles depending on the angle of the object and approach angle of the mower. In each example, obstacle O2 reflects an ultrasonic signal back to the other sensor. In FIGS. 7 and 8, sensor 104 emits signal R, and obstacle O2 reflects signal [symbol] back to left sensor 102. Sensor 102 emits signal L, which does not reach obstacle O2 or has a deflection angle away from either sensor. In FIGS. 9 and 10, left sensor 102 emits signal L, and obstacle O2 reflects signal [symbol] back to right sensor 104. Sensor 104 emits signal R, which does not reach obstacle O2 or has a deflection angle away from either sensor. The controller compares the reflected signals to determine which sensor has a reflected signal with a lower value or proximity to the object, and uses the comparison to command the traction drive system which direction to turn. In FIGS. 6 and 7, for example, left sensor 102 received a signal with a lower value (which was the only reflected signal), so the controller may command the traction drive system to turn the robotic mower clockwise (or to the right) to avoid obstacle O2. In FIGS. 8 and 9, the right sensor received a signal with a lower value (which was the only reflected signal), so the controller may command the traction drive system to turn the robotic mower counter clockwise (or to the left) to avoid obstacle O2.

Having described the preferred embodiment, it will become apparent that various modifications can be made without departing from the scope of the invention as defined in the accompanying claims.

1. A mower obstacle avoidance system, comprising:
a left ultrasonic sensor and a right ultrasonic sensor mounted on a mower; the left ultrasonic sensor sending ultrasonic signals at a first frequency and the right ultrasonic sensor sending ultrasonic signals at a second frequency; each ultrasonic sensor receiving ultrasonic signals reflected back at both the first frequency and the second frequency; and
a vehicle controller commanding a traction drive system of the mower to avoid an obstacle based on a comparison of reflected ultrasonic signals received by the first ultrasonic sensor and the second ultrasonic sensor.

2. The mower obstacle avoidance system of claim 1 wherein the vehicle controller commands the traction drive system to slow down the mower if at least one of the first and second ultrasonic sensors receives a reflected ultrasonic signal from an obstacle in a slow down zone between a maximum distance and a minimum distance from the mower.

3. The mower obstacle avoidance system of claim 2 wherein the first and second ultrasonic sensors emit ultrasonic signals each having a trajectory above a height of cut of the mower in the slow down zone.

4. The obstacle avoidance system of claim 1 wherein the vehicle controller compares the reflected ultrasonic signals to each sensor to command the traction drive system to turn the mower clockwise or counter clockwise.

5. A mower obstacle avoidance system, comprising:
a pair of sensors mounted on a robotic mower, each sensor emitting ultrasonic signals in a trajectory in front of the robotic mower; and
a controller programmed to command a traction drive system to stop and turn the mower if either of the pair of sensors receives a reflected ultrasonic signal from an object at a stop distance in front of the robotic mower, and if the object also is within a window of passage based on a height of cut, a width and a height of the robotic mower.

6. The mower obstacle avoidance system of claim 5 wherein the controller is programmed to command the traction drive system to slow down the mower before stopping the mower if either of the pair of sensors receives an ultrasonic signal reflected from an object in front of the window of passage in a slow down zone located between a maximum distance and a minimum distance from the pair of sensors.

7. The mower obstacle avoidance system of claim 5 wherein the controller is programmed to command the traction drive system to turn the mower clockwise or counterclockwise depending on the proximity of the object relative to the mower.

8. The mower obstacle avoidance system of claim 5, wherein each of the pair of sensors can receive reflected ultrasonic signals that were emitted by the other sensor.

9. A mower obstacle avoidance method, comprising the steps of:
emitting a plurality of ultrasonic signals from a plurality of ultrasonic sensors mounted to a mower;
slowing the mower from a normal speed to a reduced speed if at least one of the plurality of ultrasonic sensors receives a signal reflected from an object in a slow down zone ahead of the mower;
stopping and turning the mower if at least one of the plurality of ultrasonic sensors receives a reflected signal at a stop distance closer than the slow down zone; and
speeding up the mower from the reduced speed to the normal speed if none of the plurality of ultrasonic sensors continue receiving a reflected signal from the object in the slow down zone.

10. The mower obstacle avoidance method of claim 9 wherein the step of stopping and turning the mower further comprises comparing the reflected signals of a plurality of the ultrasonic sensors to determine which has the smallest value.

11. The obstacle avoidance system of claim 9 wherein the slow down zone has a maximum distance and minimum distance in front of the mower.

12. The obstacle avoidance system of claim 9 further comprising emitting ultrasonic signals at different frequencies from a plurality of ultrasonic sensors.
